(19) United States
(12) Patent Application Publication
(10) Pub. No.: US 2015/0358681 A1
(43) Pub. Date: Dec. 10, 2015

(54) PEER GROUP EVALUATION PROGRAM FOR MASS DISTRIBUTED DIGITAL CONTENT

(71) Applicant: Kerry R. Gaston, Montgomery, AL (US)

(72) Inventor: Kerry R. Gaston, Montgomery, AL (US)

(21) Appl. No.: 14/296,141

(22) Filed: Jun. 4, 2014

(51) Int. Cl. H04N 21/475

(52) U.S. Cl. CPC H04N 21/4758; H04N 21/4756

(57) ABSTRACT

A system and method for peer group evaluation for mass distributed digital content including providing a registry for a plurality of users and classifying each member of the plurality of users as at least one of a sender, a screener, and/or a receiver. In such systems and methods, a sender submits digital content to a server, a screener views the digital content and provides an evaluation for digital content, and a receiver receives the digital content. Further, such systems and methods receive digital content from at least one sender, send the digital content to at least one screener, and receive one or more evaluations of the digital content from the at least one screener. The systems and methods determine a rating of the content based on the one or more evaluations of the digital content and send the digital content to one or more receivers.

### TECHNICAL FIELD OF THE DISCLOSURE

The present disclosure relates to mass distribution of digital content and, more particularly, relates to a method for peer evaluation of the mass distributed digital content.

### BACKGROUND OF THE DISCLOSURE

Since the beginning of computer network and internet protocol based media systems, systems and methods have been established for distributing digital content to an individual or a group. Digital content may be, but is not limited to being any digital communication including text, video, audio, image, or any combination thereof. Such content may be distributed to and/or received by a computing device having software therein for displaying said content. Such computing devices may include, but are not limited to including, a personal computer, a laptop computer, a cellular phone, a smart phone, a tablet, and/or any other device which may send and/or receive digital content.

In the past, digital content would be received from numerous sources and distributed to a list of receivers. Good, useful, or desired digital content would be distributed to these receivers, but a vast majority of the digital content would be of poor content quality. As a result, very few users of such a service would want to receive the digital content of poor quality.

Content evaluation is necessary to filter content and remove content that is of poor quality. Such poor quality content may damage the reputation of the server hosting the content; the damaged reputation leading to significant loss of business, for example, by losing internet traffic to a website.

Systems and methods for evaluating content using a group of human beings to evaluate the usefulness of digital content for other like-minded human beings filters content in a way to eliminate many problems of prior content evaluation.

### SUMMARY OF THE DISCLOSURE

In accordance with one aspect of the present disclosure, a method is provided for peer group evaluation for mass distributed digital content, the method comprising providing a registry for a plurality of users, classifying each member of the plurality of users as at least one of a sender, a screener, and/or a receiver. A sender submits digital content to a server, a screener views the digital content and provides an evaluation for digital content, and a receiver receives the digital content. Further, the method comprises receiving, by the server, digital content from at least one sender, sending the digital content to at least one screener, receiving, by a server, one or more evaluations of the digital content from the at least one screener, determining a rating of the content based on the one or more evaluations of the digital content, and sending the digital content to one or more receivers.

In accordance with another embodiment, a method is provided for peer group evaluation for mass distributed digital content, the method comprising receiving, by a server, digital content and at least one question associated with the digital content from at least one sender, providing the digital content and the at least one question to at least one screener, receiving, by the server, at least one answer to the at least one question from the at least one screener, analyzing, by the server, the at least one answer received, and determining a final answer based on the at least one answer received.

In accordance with another embodiment, a nontransitory computer readable medium is provided having thereon instructions for providing a registry for a plurality of users, classifying each member of the plurality of users as at least one of a sender, a screener, and/or a receiver. A sender submits digital content to a server, a screener views the digital content and provides an evaluation for digital content, and a receiver receives the digital content. Further, the method comprises receiving, by the server, digital content from at least one sender, sending the digital content to at least one screener, receiving, by a server, one or more evaluations of the digital content from the at least one screener, determining a rating of the content based on the one or more evaluations of the digital content, and sending the digital content to one or more receivers.

In accordance with another embodiment, a nontransitory computer readable medium is provided having thereon instructions for receiving, by a server, digital content and at least one question associated with the digital content from at least one sender, providing the digital content and the at least one question to at least one screener, receiving, by the server, at least one answer to the at least one question from the at least one screener, analyzing, by the server, the at least one answer received, and determining a final answer based on the at least one answer received.

### BRIEF DESCRIPTION OF THE DRAWINGS

FIG. 1 is a flowchart showing a peer evaluation process according to the present disclosure;

FIG. 2 is a continuation of the peer evaluation process which began in FIG. 1;

FIG. 3 is a continuation of the peer evaluation process, continued from FIG. 2;

FIG. 4 is a continuation of the peer evaluation process, continued from FIG. 3;

FIG. 5 is flowchart showing another embodiment of a peer evaluation process according to the present disclosure.

FIG. 6 is a block diagram of an example processing system that may execute machine readable instructions of the invention.

It should be understood that the drawings are not limited to the embodiments herein, but rather, are exemplary and that the disclosed embodiments may be rearranged, combined, and/or altered. In certain instances, details which are not necessary for an understanding of this disclosure or which render other details difficult to perceive may have been omitted. It should be understood that this disclosure is not limited to the particular embodiments illustrated herein.

### DETAILED DESCRIPTION OF THE DISCLOSURE

The present disclosure provides a system and method for mass distribution of digital content, particularly, a method for peer evaluation of said mass distributed digital content.

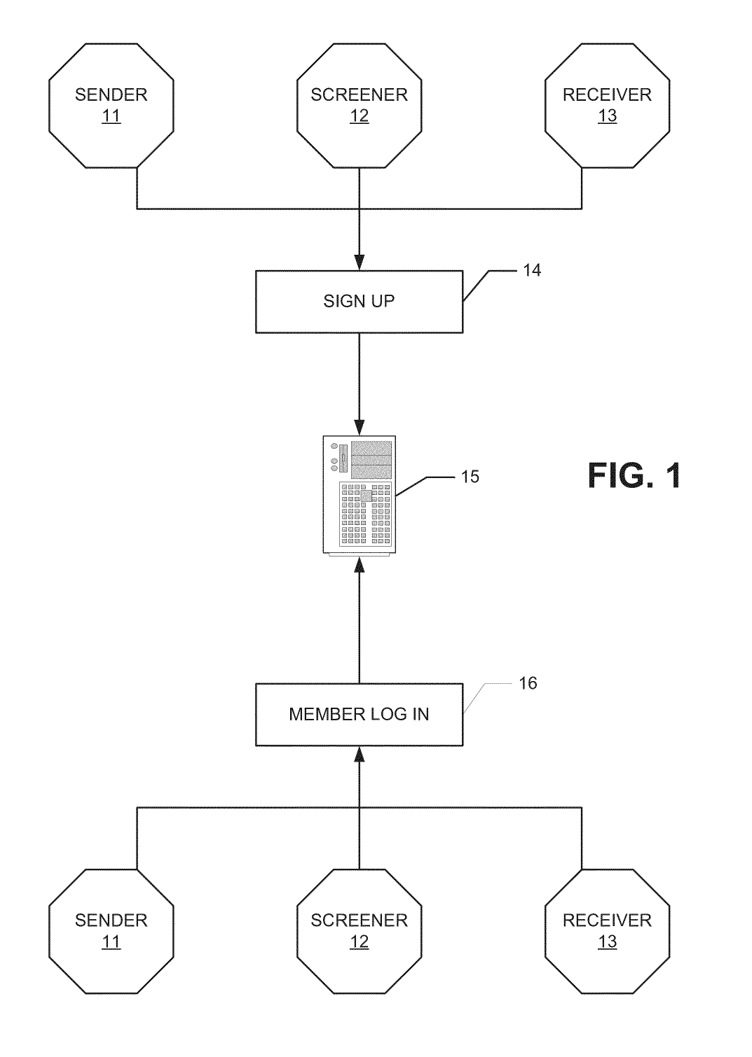

One example embodiment of the present invention is shown in FIGS. 1-4 and described in detail below. The embodiment shows a registration process and the flow of digital content through a computer based method and system. As stated above, the embodiment of FIGS. 1-4 is only one embodiment of this invention; however, any combination of the steps and/or limitations mentioned in the disclosure, including those involving human interaction with a rating or grading system of either digital content received or evaluated and/or the capabilities of evaluating exhibited by the screeners themselves and/or the senders, may be employed.

The users of such systems and methods of the current disclosure will have at least one of the following roles in the evaluation system: sender, receiver, and screener. A user may change his/her role(s) by expanding to more roles. Alternatively, a user may change his/her role(s) by diminishing his/her number of roles.

A sender is a user who sends digital content to an administrator's server. A receiver is a user that is the eventual recipient of the digital content after it has been screened or filtered. Further, a screener is a user who receives the digital content before it has been screened and/or filtered and then passes judgment on the digital content.

Additionally, the user may look at a listing of categories to determine which categories of content they would like to send, receive, or screen. For example, there may be main categories such as Sports, Entertainment, Politics, Business, and/or People. Further, such main categories may be broken down further into subcategories; for example, a user selecting sports could see a listing for “College Football.” There may be any number of further subcategories for a user to select. Such listings may go from general (i.e., “Sports”) to specific (i.e., “College Football”) and the user could decide categories based on his/her own interests. Alternatively, the list could be an alphabetical list with no hierarchy of subjects and/or categories. Such lists of topics may expand based on the user's preference. Additionally or alternatively, new categories could be based in their logical point in an alphabetical listing.

Once a user has selected his/her roles, he/she will determine, for each role, his/her participation level. This can be done with an answer to a general question involving “all” or “pick and choose” as it pertains to how much involvement they want as to each level of participation. For example, consider a user has selected “American Revolutionary War” as a category. He/she may then choose to have the role of one or more of sender, receiver, and/or screener with regards to the category “American Revolutionary War.” At any time, the user may go back to the entry level profiles and change his/her preferences.

If a user chooses only sender, he/she controls the level of involvement with the digital content. In other words, if he/she sends in digital content, then he/she will have an active involvement. If he/she does not send in any digital content, he/she does not have an active involvement.

If a user chooses only receiver, then he/she can choose the maximum number of times that he/she wants to receive anything in a selected available category. Additionally, he/she may choose how frequently he/she wants to receive digital content related to an available category. A receiver may receive as much or as little digital content as deemed fit by the user and/or an administrator. Further, in terms of responsibilities, a receiver may have very little or non-existent responsibilities. He/she may be instructed that, after each piece of digital content he/she receives, he/she will be asked to evaluate his/her desire or need for the information.

If a user chooses to be a screener, then he/she can choose the maximum number of times and frequency that he/she will receive any digital content that is forwarded to him/her under the category or categories that he/she chooses. Similar to the receiver, the screener may receive as much or as little digital content as deemed fit by the user and/or an administrator. A sender will be instructed on how to send the digital content and what type of information is not acceptable (i.e., obscene material, copyrighted material). A screener may receive extensive instructions which will detail his/her responsibility to carefully and seriously screen the digital content.

Turning to FIG. 1, once a user has decided which type of user he/she wants to be (at least one of the sender 11, the screener 12, and/or the receiver 13), he/she signs up for the service by entering a very limited amount of information about himself/herself (block 14). For example, to initiate the registry process, the user must first go to a website and register with very basic information (for example, a name, an email address, a user identification handle, a password, etc.). Such registry information is received by the server 15. To send digital content to the server 15, the user must sign-in and then select a category to index his/her digital content at the log in (block 16). If a category is not there, then the user may create one.

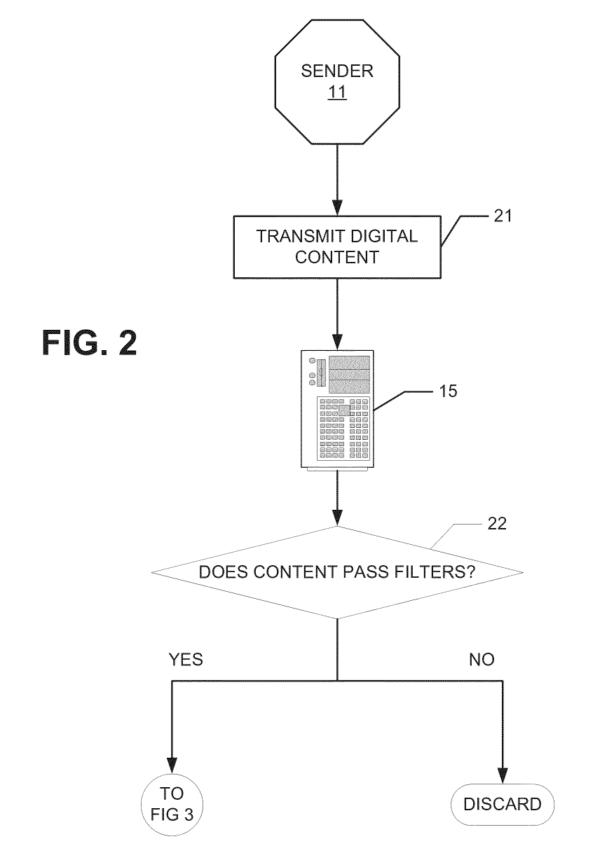

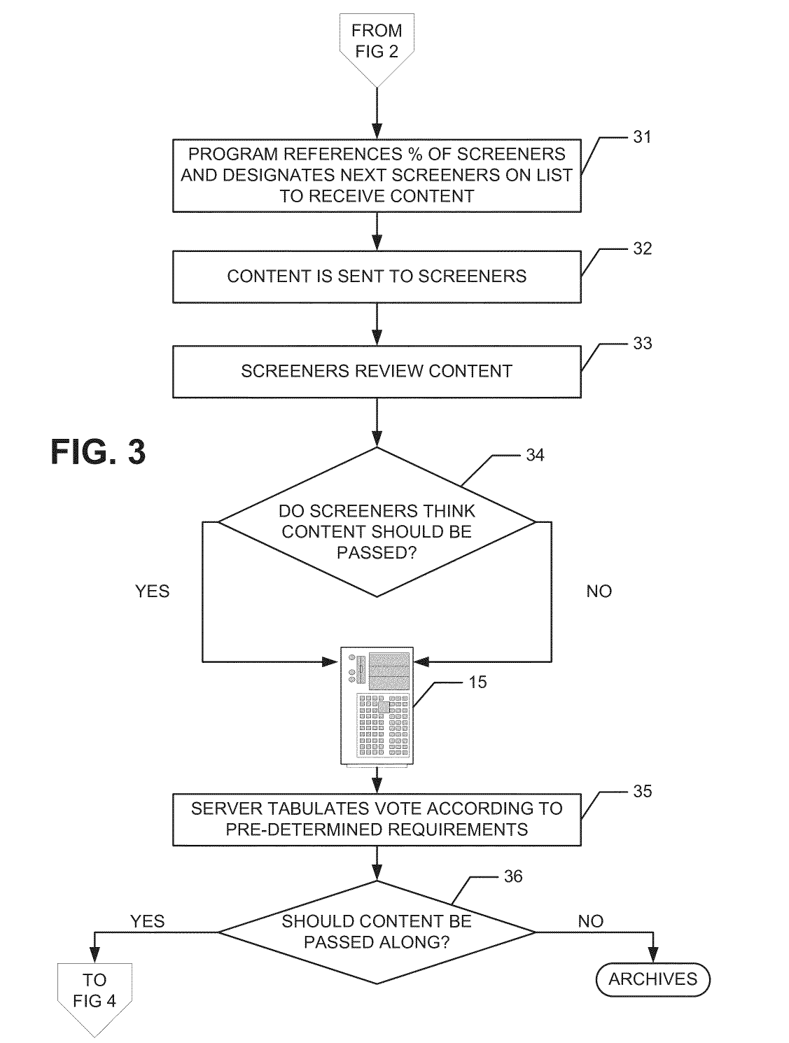

At FIG. 2 and using the example of an existing category that has a number of receivers and senders, the user would send his/her digital content to a server 15. This digital content would now be labeled for programming purposes with the sender's identification (which is not passed along to receivers or screeners) and the specific category. If the content passes the category filtering, the process continues to FIG. 3, otherwise the content is discarded (decision 22).

The server 15 would then select the screeners based on a predetermined percentage (for example, 5% of the total number of screeners or receivers) plus pre-entered willingness to serve as screeners and their number of times they want to be sent this type of material to screen (block 31).

The server 15 sends the digital content to the specified number of screeners along with their specific instructions about reviewing the information (block 32). The instructions may depend on what type of evaluation is asked of the screeners. For example, if the screener is asked, “should this information be sent on to anyone else?” or “did you want to get this?” then the answer is “yes” or “no.” If the statement is, for example, “please evaluate this information,” then the screener may be given a choice between, for example, 1-5, 1-10, 1-100, etc.

The screeners 12 may have a predetermined time in which to respond and only the number of screeners that do respond will be considered in the final tally (decision 34). If it is a “yes” or “no” question, it may be a majority vote or it may be another percentage that is selected to pass the digital content along to all of the other receivers (block 35). If it is an evaluation based on points, then the program may require that the total sent in by the responding screeners reach a certain number.

The server may tabulate a vote according to predetermined requirements (block 35). The system will then decide whether or not the content should be passed downstream (decision 36). If the screeners reject the digital content purely on its worth, then the information is not lost, but instead is sent to an archives section under that particular category. In this way, anyone wanting to see what was not passed on to them could review all of the digital content. Exceptions may apply, for example, if the materials are rejected because of copyright or obscenity problems. The screeners may also have the question of copyright or obscenity or any other objection posed to them as the evaluation question. Also, when the screener's response is sent back to the server, the response will also contain their identification information.

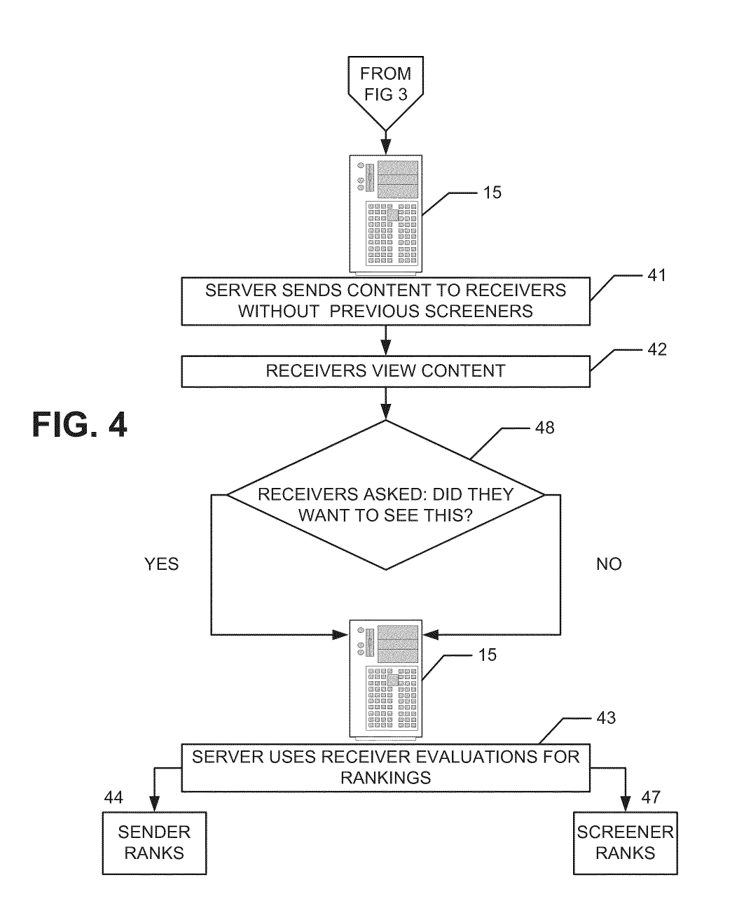

Returning to block 36, if the screeners 12 decide the content should be passed along, as determined by the server 15 tallying up the evaluations, then the digital content is passed on to the receivers 13 (to FIG. 4).

When the receivers 13 receive the digital content (block 41), they do not have a specific time period in which to view said content (block 42), but they will be asked to evaluate the digital content they received. The receivers will be asked if the digital content was something they wanted to see and prompted for a response (i.e., yes/no) (decision 48).

After receiving yes/no responses from the receivers, the server will use these answers to “grade” both the senders 11 and the screeners 12 (block 43). Senders 11 will be graded on sending in acceptable material (block 44). For example, if senders 11 send in something that is copyrighted, they can be removed from the list of senders or they can be sent a warning. If an evaluation score is low, a programmed response based on a score will determine if the sender is to be eliminated from the list or if his/her activity is to be curtailed to some degree. This may eliminate senders that send in trite or routinely uninteresting digital content. Conversely, a high evaluation could lead to the sender being digitally contacted and encouraged to send in more digital content. There may be a ratings system that gives grades and/or preference to these high scoring senders.

Screeners 12 may also receive scores based on the general acceptance of the material that they have rejected or passed along (block 47). A screener 12 that passes along unacceptable material even though it is clearly a copyright infringement or obscene may be dropped at some point as a screener, as will a screener that appears to go against the grain of the receivers wants or desires as to what digital content they want to see. As with the senders 11, some screeners 12 may get higher scores and they will be encouraged to expand the amount of times that they participate in screening.

The server 15 may internally screen out digital content that is repetitious, as many users may send in the same or substantially similar content. The server may be programmed to pass only one of such repetitious content along and to screen out the near duplicates.

In addition to the previously described systems and methods, another embodiment with additional features is disclosed. In an example embodiment, users may ask specific questions or search requests in a particular category or topic. Such questions would only be sent to receivers 13 that would be registered under that category or topic. Answers could be relayed back to the original questioner or could be posted in a section under, indexed, and/or referenced in conjunction with that particular category or topic. Alternatively, the answers could be routed back through a group of screeners 12 who evaluate the answers and select the best one or best ones. These answers in turn would be sent back to the original questioner or displayed as mentioned above.

Some example systems and methods may include a sales feature that may or may not involve screener 12 participation. If a receiver 13 registers under a general sales category, the receiver 13 may want to receive information on the sale or availability of one or more items. One embodiment would have any digital content involving a particular item or any items on sale or available (depending on the category) pass through a group of screeners 12 to evaluate the worth of the information. A positive reaction based on a predetermined percentage of votes or evaluation criteria would then send this digital content on to the receivers registered under that category. Another embodiment involving a sales feature would have the digital content go directly to the receivers registered under that category or topic. In either and all embodiments of sales features, the receivers 13 (and the screeners 12) would have the opportunity to purchase the item or service directly through a website or digital connection. Such a sales feature would allow an individual to direct buy a product or service by clicking on a button (or other means of selection) that would allow for an immediate purchase, particularly if the user had entered credit information on his/her now expanded entry-level profile.

Some example systems and methods include a digital content distribution system that combines the peer evaluation process described herein with a digital content distribution system that resembles the type of digital content displayed or received from a newspaper or magazine type digital content provider. One embodiment including this feature would allow the receiver 13 to receive all of the latest digital content plus any pre-selected digital content that the user would like to receive that does not go through a peer evaluation or review process on the user's computing device. For example, the receiver 13 could receive all of the digital content that passed peer evaluation as described in this disclosure plus any daily editorials, sports features, weather, business reports, comics, and/or any other digital content that the user had previously indicated an interest in receiving. Such features may be paid for by subscription or per receipt of the digital content and/or it may be financially sustained by some other combination of revenue paths, such as advertising.

Other example systems and methods may additionally or alternatively include a social networking feature that is based on common interests of the users. Such features are accomplished by allowing more interaction between the users under individual categories, subjects or topics. Said features may also include the expansion of the user's entry-level profile or registration page to include additional information about the user. Such additional information may be a requirement for using this feature. In one embodiment, a user may voluntarily expand his/her entry-level profile (or, alternatively, simply place existing profile information into the social network feature for participation) and indicate his/her desire to participate in the feature in one or more categories or topics. Once the user has entered his/her profile into this feature under a certain category, all other similar feature participants will now have the ability to view that profile or communicate directly with that user or both or be able to participate in additional communication areas. As long as the user has consented to this participation in the social networking feature under one or more categories, this type of communication can occur with other users under a particular category or topic. If the user wants to exit that particular category and cease the direct communication or participation with the other users partaking in this feature under that category or topic, then a simple removal or deleting of, for example, the “checkmark” that denoted consent to participation in the social networking feature under that category or topic, will remove the user from further participation. If the user has given out any personal information that may be recorded and/or kept by another method after deletion of his/her profile, then there may be a method for tracking the user using said information.

Similarly, disclosed systems and methods may use such methods to have users find other users having similar interests. Some such systems and methods may be used for a dating or match making application.

The screeners of the disclosed systems and methods for peer evaluation may be voluntary as users of the service or they may be paid workers. They may do screening at either an office, from the user's home, any remote location, or any combination thereof. Any screener, whether volunteer or paid, would receive an evaluation of his/her work by the receivers.

The disclosed systems and methods may be used by private companies, social entities, and/or government agencies to pass along information from one member to all of their members after the material has been screened. For example, an employee could pass along a tip or some useful information to the server where it is sent to a limited number of screeners to determine if this information should be passed along or if it is a waste of time. Management could have control of the system or the system could be private and only accessible to those that management would decide upon.

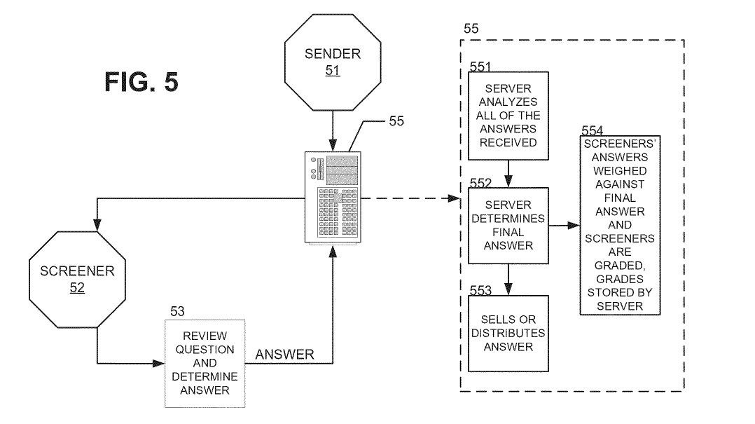

Similar evaluation systems and methods may be implemented in another embodiment of the present invention as detailed in FIG. 5. In such an embodiment, the senders 51 would be a company that runs the system and/or method or an entity that has hired the company that runs the system and/or method. The senders 51 would send a request for the screeners 52 (through the server 55) to evaluate, rate or score a certain subject that may or may not occur in the immediate future. The screeners 52 would comply with the request and send their results to the server 55 (block 53). Within the server, a process may be run which will analyze all of the answers received (block 551), determine a final answer (block 552), and/or sell or distribute said final answer (block 553). Additionally, the screeners performance scores would not be derived from receivers, but may be derived from the accuracy of their answers based on what actually happened in that future event (block 554). The more accurate a screener is, the more weight is put on his/her answers.

An example application of the process of FIG. 5 may be as follows: A company sends out a request; for example, a prediction for the score of a Bears-Cowboys football game. The company receives an assortment of answers and then statistically analyzes said answers to derive the possible future score. Said future score could be sold to those interested in that game's outcome. After the game is played and the score is precisely determined, the screeners are then graded and any future analysis takes their grades into account. As time goes on and more games are played and more data comes in, a more accurate picture of future games should appear. Such processes could be applied to other future events such as, for example, stock or commodity prices.

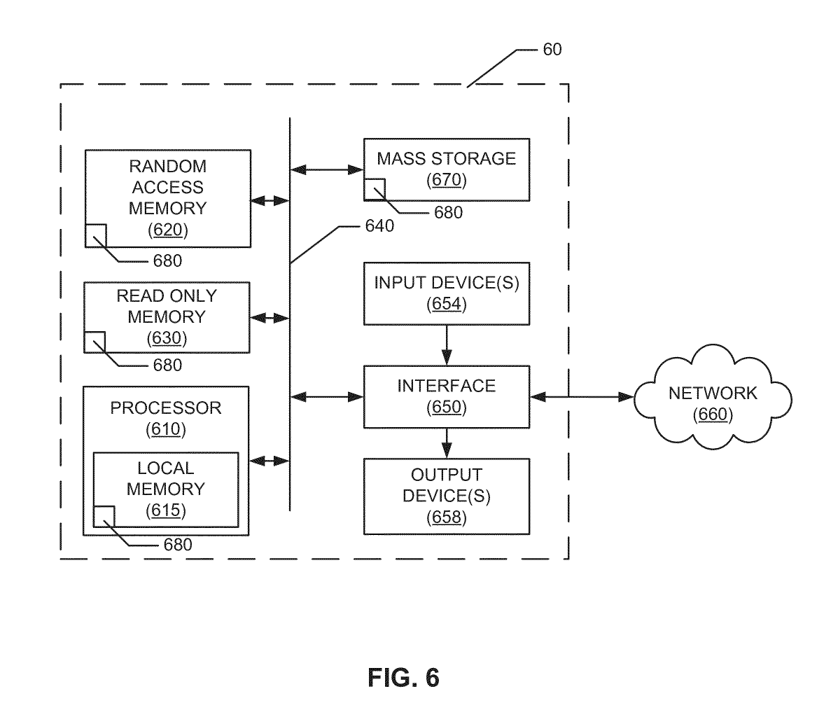

FIG. 6 is a block diagram of an example computing device 60 capable of executing the instructions of FIGS. 1-5 and/or to implement any of the disclosed systems and methods. The computer 60 can be, for example, a server, a personal computer, or any other type of computing device.

The system 60 of the instant example includes a processor 610. For example, the processor 610 can be implemented by one or more microprocessors or controllers from any desired family or manufacturer.

The processor 610 includes a local memory 615 and is in communication with a main memory including a read only memory 630 and a random access memory 620 via a bus 640. The random access memory 620 may be implemented by Synchronous Dynamic Random Access Memory (SDRAM), Dynamic Random Access Memory (DRAM), RAMBUS Dynamic Random Access Memory (RDRM) and/or any other type of random access memory device. The read only memory 630 may be implemented by a hard drive, flash memory and/or any other desired type of memory device.

The computer 60 also includes an interface circuit 650. The interface circuit 650 may be implemented by any type of interface standard, such as an Ethernet interface, a universal serial bus (USB), and/or a PCI express interface.

One or more input devices 654 are connected to the interface circuit 650. The input device(s) 654 permit a user to enter data and commands into the processor 610. The input device(s) can be implemented by, for example, a keyboard, a mouse, a touchscreen, a track-pad, a trackball, isopoint and/or a voice recognition system. The interface 650 may operate in conjunction with, in parallel with, or in place of, any user interface.

One or more output devices 658 are also connected to the interface circuit 650. The output devices 658 can be implemented by, for example, display devices for associated data (e.g., a liquid crystal display, a cathode ray tube display (CRT), etc.).

The interface circuit 650 may include a communication device such as a modem or network interface card to facilitate exchange of data with external computers via a network 660.

The computer 60 also includes one or more mass storage devices 670 for storing software and data. Examples of such mass storage devices 670 include floppy disk drives, hard drive disks, compact disk drives and digital versatile disk (DVD) drives. The mass storage device may implement any storage devices.

The coded instructions 680 may be stored in the mass storage device 670, in the random access memory 620, in the read only memory 630, in the local memory 615, and/or on a removable storage medium such as a CD, DVD, and/or flash memory device.

While only certain embodiments have been set forth herein, alternatives and modifications will be apparent from the above description to those of skill in the art. These and other alternatives are considered equivalents and within the spirit and scope of this disclosure and the appended claims.

What is claimed is:

1. A method for peer group evaluation for mass distributed digital content, the method comprising:
providing a registry for a plurality of users;
classifying each member of the plurality of users as at least one of a sender, a screener, and a receiver;
wherein a sender submits digital content to a server, a screener views the digital content and provides an evaluation for the digital content, and a receiver receives the digital content;
receiving, by the server, digital content from at least one sender;
sending the digital content to at least one screener;
receiving, by the server, one or more evaluations of the digital content from the at least one screener;
determining a rating of the digital content based on the one or more evaluations of the digital content; and
sending the digital content to one or more receivers.

2. The method for peer group evaluation for mass distributed digital content of claim 1, the method further comprising filtering the digital content provided by the at least one sender.

3. The method for peer group evaluation for mass distributed digital content of claim 2, wherein the filtering removes repetitious digital content.

4. The method for peer group evaluation for mass distributed digital content of claim 1, wherein determining a rating of the content based on the one or more evaluations of the digital content comprises:
determining a reference percentage of screeners;
designating which of the at least one screeners will receive content;
receiving evaluations from the screeners who received content; and
determining if the content should be passed based on pre-determined requirements.

5. The method for peer group evaluation for mass distributed digital content of claim 1, the method further comprising determining evaluations of the digital content based on opinions of the at least one receivers.

6. The method for peer group evaluation for mass distributed digital content of claim 5, wherein the evaluations of the digital content based on the opinions of the at least one receivers are used to determine rankings for the at least one senders.

7. The method for peer group evaluation for mass distributed digital content of claim 5, wherein the evaluations of the digital content based on the opinions of the at least one receivers are used to determine rankings for the at least one screeners.

8. The method for peer group evaluation for mass distributed digital content of claim 1, wherein the digital content is divided into at least one content category.

9. The method for peer group evaluation for mass distributed digital content of claim 8, wherein the plurality of users determine at least one user category based on the at least one content category.

10. The method for peer group evaluation for mass distributed digital content of claim 1, the method further comprising indexing user questions related to the digital content.

11. The method for peer group evaluation for mass distributed digital content of claim 1, further comprising associating the digital content with a sales feature, wherein the sales feature comprises providing sales information based on positive responses from a user.

12. The method for peer group evaluation for mass distributed digital content of claim 1, further comprising associating the digital content with a digital content distribution feature, wherein the digital content distribution feature comprises providing digital content based on categories selected from a user.

13. The method for peer group evaluation for mass distributed digital content of claim 1, further comprising associating the digital content with a social networking feature, wherein the social networking feature comprises providing interaction between the plurality of users based on like responses from the plurality of users.

14. The method for peer group evaluation for mass distributed digital content of claim 1, further comprising associating the digital content with a dating feature, wherein the dating feature comprises providing match-making based on like responses from a user.

15. A method for peer group evaluation for mass distributed digital content, the method comprising:
receiving, by a server, digital content and at least one question associated with the digital content from at least one sender;
providing the digital content and the at least one question to at least one screener;
receiving, by the server, at least one answer to the at least one question from the at least one screener;
analyzing, by the server, the at least one answer received; and
determining a final answer based on the at least one answer received.

16. The method for peer group evaluation for mass distributed digital content of claim 15, the method further comprising selling the final answer to a third party.

17. The method for peer group evaluation for mass distributed digital content of claim 15, the method further comprising distributing the final answer to a third party.

18. The method for peer group evaluation for mass distributed digital content of claim 15, the method further comprising weighing the at least one answer against the final answer to determine a performance grade for the at least one screener.

19. A nontransitory computer readable medium having thereon instructions for performing a method for peer group evaluation for mass distributed digital content, the instructions comprising:
instructions for providing a registry for a plurality of users;
instructions for classifying each member of the plurality of users as at least one of a sender, a screener, and/or a receiver;
wherein a sender submits digital content to a server, a screener views the digital content and provides an evaluation for digital content, and a receiver receives the digital content;
instructions for receiving, by the server, digital content from at least one sender;
instructions for sending the digital content to at least one screener;
instructions for receiving, by the server, one or more evaluations of the digital content from the at least one screener;
instructions for determining a rating of the content based on the one or more evaluations of the digital content; and
instructions for sending the digital content to one or more receivers.

20. A nontransitory computer readable medium having thereon instructions for performing a method for peer group evaluation for mass distributed digital content of claim 19, the method further comprising instructions for filtering the digital content provided by the at least one sender.
